(19) United States
(12) Patent Application Publication
(10) Pub. No.: US 2005/0051696 A1
(43) Pub. Date: Mar. 10, 2005

(54) Anti-theft device

(75) Inventor: F. Werner Oberpichler, Garson (CA)

Correspondence Address: ADE & COMPANY, 1700-360 MAIN STREET, WINNIPEG, MB, R3C3Z3, CA

(73) Assignee: Wayne Lawrence Ewasko, Beausejour (CA)

(21) Appl. No.: 10/655,029

(22) Filed: Sep. 5, 2003

(51) Int. Cl. F16M 13/00

(52) U.S. Cl. 248/551

(57) ABSTRACT

An anti-theft device and method of use are provided for securing a portable propane appliance, for example a propane barbeque or a propane consuming mosquito trap. The anti-theft device includes an anchor secured to either the ground or a similarly fixed object and a bracket secured to the appliance. In preferred embodiments, the bracket is secured to a wheel axle of the appliance and is concealed below a base housing of the appliance. A tongue on the bracket is slidably received through an eye of the anchor and is arranged to receive a lock through an aperture in a free end thereof so as to restrict removal of the tongue from the eye.

### FIELD OF THE INVENTION

The present invention relates to an anti-theft device and method of use of the device for securing a portable appliance, for example a wheeled propane barbeque or a wheeled propane consuming mosquito trap, to a fixed anchor for protection against theft.

### BACKGROUND

Portable appliances for use outdoors are commonly known for performing various functions. Examples of appliances include propane barbecues, propane heaters and propane consuming mosquito traps. These appliances are typically positioned in a person's yard so as to be readily susceptible to theft.

Examples of anchoring devices for securing objects to the ground can be found in U.S. Pat. No. 3,747,288 to Grimelii, U.S. Pat. No. 3,848,367 to Barnes, U.S. Pat. No. 5,094,423 to Almquist et al, U.S. Pat. No. 5,501,086 to Sherlock, U.S. Pat. No. 5,623,843 to Sands, U.S. Pat. No. 5,813,259 to Martin, U.S. Pat. No. 5,881,978 to Rust, U.S. Pat. No. 5,855,129 to Warren et al and finally U.S. Pat. No. 6,082,697 to Grunfeld. Among these devices for anchoring objects to the ground, none appear to be particularly suited for portable appliances to protect against theft thereof.

### SUMMARY

According to one aspect of the present invention there is provided a method of securing a portable propane appliance, the method comprising:
providing an anti-theft device including an anchor having an eye and an anchoring portion and a bracket having a tongue for being slidably received in the eye and a locking aperture at a free end of the tongue;
securing the anchoring portion of the anchor to either the ground or a similarly fixed object;
securing the bracket to the appliance;
inserting the tongue of the bracket through the eye of the anchor; and
securing a locking member through the locking aperture in the tongue so as to restrict removal of the tongue from the eye.

According to a second aspect of the present invention there is provided an anti-theft device for a portable appliance, the device comprising:
an anchor having an eye and an anchoring portion for securement to either the ground or a similarly fixed object;
a mounting bracket for securement to the portable appliance; and
a tongue projecting from the bracket and being suitable sized for being slidable into the eye of the anchor;
the tongue locating a locking aperture in a free end thereof to receive a locking member therethrough for selectively restricting removal of the tongue from the eye of the anchor.

The simple construction of the anti-theft device including means for securement to an appliance and a tongue which can be secured to conventional ground anchors and the like ensures proper securement of portable appliances including propane barbecues or mosquito traps and other related propane consuming devices. The simplicity of the construction of the anti-theft device can be readily manufactured as well as installed. In most applications, the device can be concealed and hidden from view underneath the base of the appliance. In this manner the device is difficult to tamper with using wrenches or other tools in the form of hacksaws or bolt cutters as such tools would be ineffective due to the concealed nature of the components of the device. Simple removal of the padlock however is sufficient for the anti-theft device to be readily removed by wheeling the appliance from the ground anchor without lifting being required. By providing multiple ground anchors, the anti-theft device readily permits an appliance to be locked down into one of plural locations for either winter storage in sheds, garages, on decks, and on patios, for example at the cottage and the like.

The bracket may be suitably arranged for securement below a base of the appliance so that the tongue projects below the bracket for concealment below the base of the appliance.

Preferably the bracket includes spaced apart apertures therein for slidably receiving an axle of the appliance therethrough and for securement at spaced positions along the axle.

There may be provided axle locking means for securement of the bracket to the axle and for restricting longitudinal sliding movement of the axle relative to the bracket. When the bracket includes a pair of spaced apart flanges having apertures therein for slidably receiving an axle of the appliance therethrough, the axle locking means may be secured to the axle between the spaced apart flanges.

In one embodiment, the bracket includes a pair of axle mounts which are slidably supported relative to one another for mounting on an axle of the appliance at adjustably spaced locations.

In some embodiments, a guard flange preferably at least partially surrounds the tongue, spaced outwardly from the tongue.

For additional security, the eye of the anchor is preferably welded to form a closed loop.

In one configuration, the anchoring portion of the anchor comprises a threaded rod for securement with suitable threaded nuts for locking the appliance to a deck and the like. Alternatively, the anchoring portion of the anchor may comprise flighting which is suitably arranged for insertion into the ground.

The bracket is particularly suited for securement to a portable propane consuming appliance, for example a portable, wheeled, propane barbeque or a portable, wheeled, propane consuming mosquito trap of the type readily available under the trademark name Mosquito Magnet.

In some arrangements, the bracket may include mounting apertures for securement to a frame of the appliance using suitable fasteners.

Any fasteners used for securement of the bracket to the appliance are preferably secured using a suitable adhesive compound.

### BRIEF DESCRIPTION OF THE DRAWINGS

In the accompanying drawings, which illustrate exemplary embodiments of the present invention:

FIG. 1 is a perspective view of a first embodiment of the anti-theft device.

FIG. 2, FIG. 3 and FIG. 4 are respective front elevational, side elevational and bottom plan views of the device according to FIG. 1.

FIG. 5, FIG. 6 and FIG. 7 are respective side elevational, rear elevational and top plan views of the device according to FIG. 1 as installed on a propane consuming portable mosquito trap.

FIGS. 8 and 9 are respective first and second embodiments of the anchor used to secure the anti-theft device.

FIG. 10, FIG. 11 and FIG. 12 are respective side elevational, rear elevational and top plan views of a second embodiment of the anti-theft device.

FIG. 13, FIG. 14 and FIG. 15 are respective side elevational, end elevational and bottom plan views of a third embodiment of the anti-theft device.

FIGS. 16, 17 and 18 are respective side elevational, end elevational and bottom plan views of the third embodiment of the ant-theft device shown installed on an appliance.

FIG. 19, FIG. 20 and FIG. 21 are respective top plan, front elevational and side elevational views of a fourth embodiment of the anti-theft device.

FIGS. 22, 23 and 24 are respective side elevational, rear elevational and bottom plan views of the fourth embodiment of the anti-theft device as installed on a propane appliance.

FIG. 25 is a partly sectional view illustrating the assembly at each end of the anti-theft device according to the fourth embodiment.

FIGS. 26, 27 and 28 are respective rear elevational, side elevational and bottom plan views of a fifth embodiment of the anti-theft device.

FIG. 29 and FIG. 30 are respective rear elevational and bottom plan views of the fifth embodiment of the anti-theft device installed on a propane appliance.

FIG. 31 illustrates an alternate clamp for use with the fifth embodiment of the anti-theft device.

FIGS. 32, 33 and 34 illustrate side elevational, rear elevational and bottom plan views of a sixth embodiment of the anti-theft device.

FIGS. 35 and 36 are respective top plan and side elevational views of the sixth embodiment installed on a portable propane appliance.

### DETAILED DESCRIPTION

Referring to the accompanying drawings, there is illustrated an anti-theft device generally indicated by reference numeral 10. The device 10 is particularly suited for protecting a portable appliance from theft. In particular the anti-theft device 10 is well suited for securement of portable propane consuming appliances including wheeled barbecues, wheeled mosquito traps and propane heaters and the like which are commonly located in a person's yard.

While various embodiments are described later herein, the common features of each will first be noted as follows. In the Figures, like reference numerals correspond to similar parts in the different embodiments. The device 10 includes a bracket 12 which is suitably arranged for securement to the appliance 14. A tongue 16 projects from the bracket 12 which includes a locking aperture 18 towards a free end 20 thereof. The anti-theft device 10 works in cooperation with an anchor 22 of the type having an anchoring portion 24 in the form of an elongate shaft suitably arranged for securement to the ground or other similarly fixed object. The anchor 22 further includes an eye 26 fixed to the free end of the anchoring portion 24 similarly to conventional ground anchors and the like.

The tongue 16 is suitable arranged for being slidably received within the eye 26 in such a manner that the bracket is located on one side of the eye with the locking aperture 18 in the tongue being sufficiently spaced from the bracket to be positioned on the opposing side of the eye when the tongue is inserted therethrough. A suitable locking member 28 is then inserted through the locking aperture 18 and secured to the tongue in such a manner that the tongue is restricted from removal from the eye 26 of the anchor 22. The eye 26 of the anchor is welded to form a closed loop so that even if the eye were to be cut, the tongue cannot be removed until a second cut is made to remove a section of the eye through which the tongue could be removed. In any embodiment, the tongue is generally positioned so as to be concealed either below the appliance 14 itself or it is guarded by components of the bracket 12.

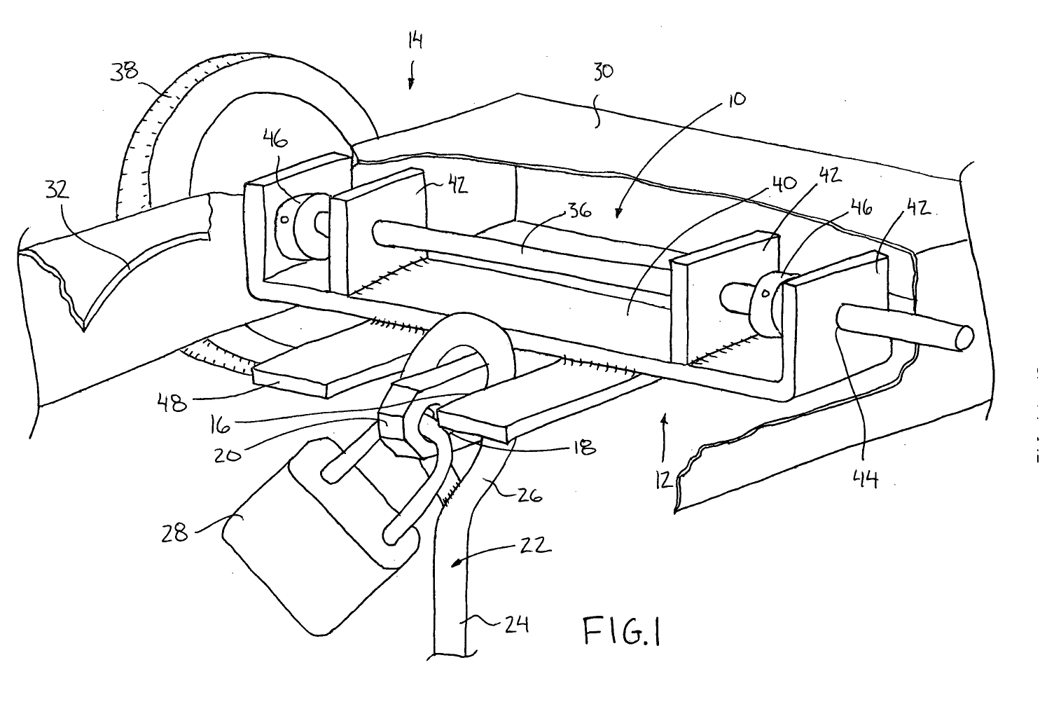

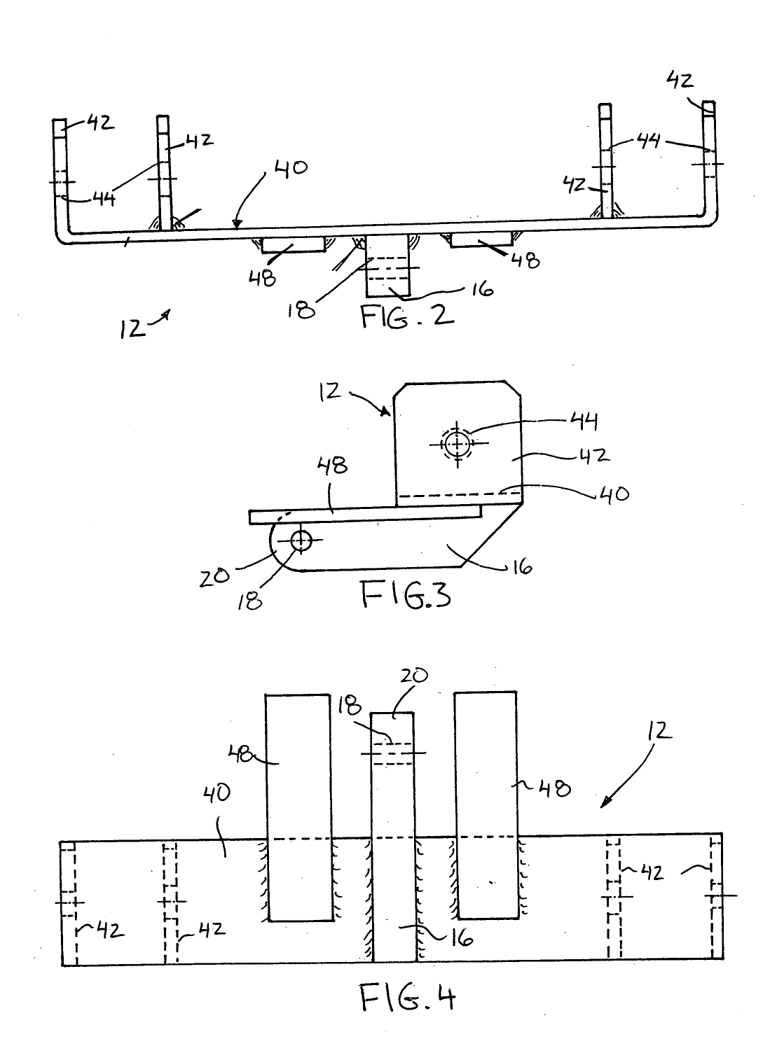

Turning now to FIGS. 1 through 7, a first embodiment of the anti-theft device will now be described in further detail. In the embodiment of FIG. 1, the bracket 12 is particularly suited for an appliance 14 of similar construction to large models of propane consuming mosquito traps available under the trademark name Mosquito Magnet. An appliance of this nature includes a rectangular base housing 30 having a square upper surface and side walls depending from each of the edges of the upper surface. A circular opening 32 is located in the upper surface for positioning of a propane tank 34 thereon. Apertures are provided in opposing side walls of the housing for receiving an axle 36 therethrough which mounts a pair of wheels 38 at opposing ends thereof. The wheels may be secured at opposing ends of the axle using conventional fasteners.

The bracket 12 in this instance is arranged for securement to the axle 36 so as to be concealed within an underside of the base housing 30. The bracket includes a main bar 40 which spans the length of the axle within the interior of the side walls of the housing. A pair of mounting flanges 42 project from the main bar perpendicularly thereto at spaced positions from each other, at each end of the main bar. Mounting apertures 44 are provided in each of the four mounting flanges 42 in coaxial alignment with one another for slidably receiving the axle 36 of the appliance therethrough upon installation.

Once installed on the axle, the main bar 40 is fixed in position relative to the axle by securing a locking collar to the axle between the pair of flanges at each end of the main bar whereby rotation of the axle is permitted in its normal fashion within the mounting apertures of the bracket but the locking collars 46 act to restrict longitudinal sliding movement of the axle relative to the bracket and the appliance so that the bracket cannot be removed from the appliance by simply slidably removing the axle.

The tongue 16 in this instance is centrally located on the main bar 40 to project perpendicularly thereto in a horizontal direction towards the opening 32 in the base housing. The aperture in the free end of the tongue 16 is thus readily accessible through the opening in the housing of the appliance to readily permit securement of the locking member 28 thereto. The locking member may be any suitable form of padlock or locking device.

Once the tank 34 is placed into the opening of the housing in its normal position of operation, the components of the anti-theft device 10 are fully concealed below the base of the appliance. To further safeguard the locking member and the eye of the anchor 22, guard flanges 48 are provided which are parallel and spaced on opposing sides of the tongue above the locking aperture 18 therein. Each of the guard flanges 48 is formed of a durable metal of similar composition to the tongue and remaining components of the bracket so that all of the components may be securely welded to one another.

By securing the axle at spaced positions with the base of the housing while further restricting relative sliding movement between the bracket and the axle, the appliance is readily secured against theft as it would be difficult to tamper with either the locking member or the axle to remove the bracket from the appliance. For additional security, any fasteners used, for example at the locking collars 46, may be secured by suitable adhesive compounds for locking the collars permanently in a mounted position. With the tongue oriented in a horizontal position securement is achieved by it simply rolling the appliance on its wheels towards the anchor which has already been suitable secured so that the tongue aligns with the eye of the anchor after which point it can be secured with the locking member 28.

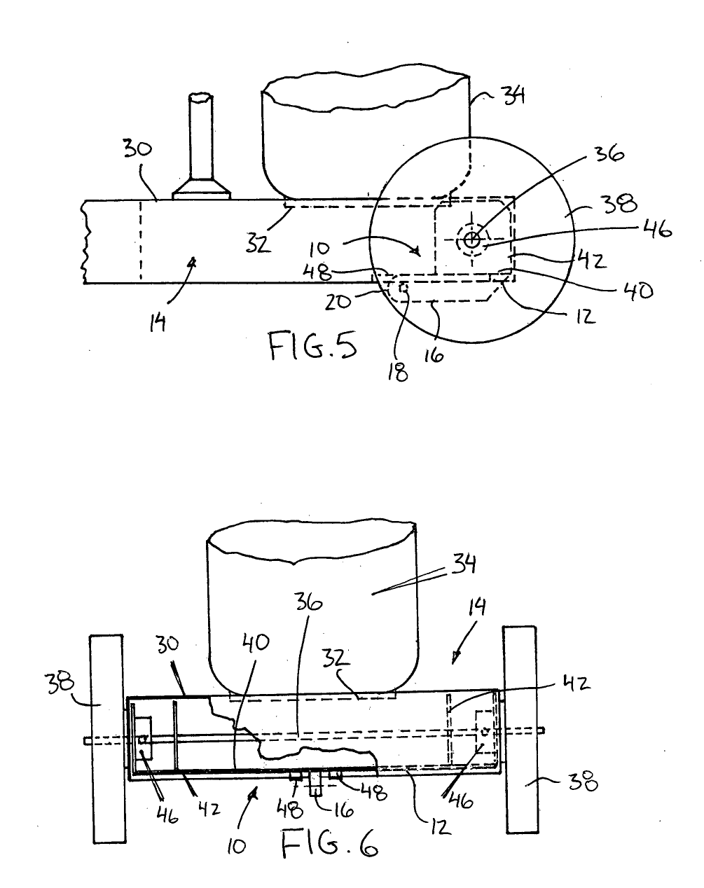

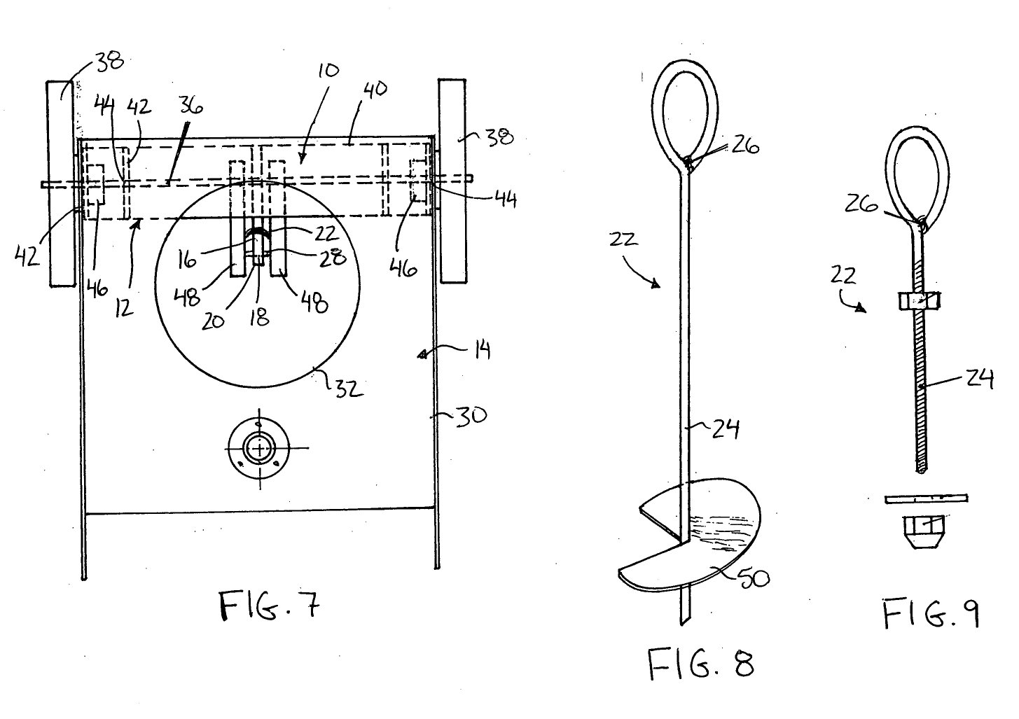

As illustrated in FIG. 8 a first embodiment of the anchor 22 is illustrated in which the anchoring portion 24 comprises a screw of the type which is commonly used for insertion into the ground. In this embodiment a flight 50 is located about the shaft at one end thereof opposite the eye 26 in a helical screw pattern. Length of the shaft may be shorter, in the range of two feet for denser materials such as lawn covered earth and soil, however a longer shaft in the order of three feet or more may be desirable for looser more particulate materials such as sand. The insertion into the ground is readily accomplished by inserting a cross member through the eye of the anchor perpendicularly to the shaft to provide assistance in applying torque to the shaft so that rotation of the flight pulls the shaft downwardly into the ground. Rotation continues until the eye 26 of the anchor is located only slightly above the surface of the ground, possibly in the order of one or two inches.

In a second embodiment of the anchor 22 as illustrated in FIG. 9, the anchoring portion 24 comprises a threaded rod which may be readily secured to numerous types of fixed objects. In one embodiment the threaded rod may be set within epoxy compounds or quick set concrete within a bore drilled into a concrete pad for securement to the concrete pad. Alternatively, for securement to a deck the threaded rod may be inserted through a bore in the deck with threaded nuts being secured on opposing sides of the deck along the threaded rod. Suitable adhesive compounds for securing the nuts in place along the threaded rod may be desirable. Use of washers or nuts having self locking nylon washers therein may be used as desired.

Turning now to a second embodiment of the anti-theft device 10 as illustrated in FIGS. 10 through 12, the configuration of the first embodiment may be shortened with dimensions slightly varied for use with a similar appliance of slightly different size. In the appliance for which the second embodiment is suitable for use, the base housing 30 is provided with an internal frame member 54 along each side thereof to which two wheels 56 are respectively secured independently of one another. Each wheel includes its own respective axle 58 for securement to the respective internal frame member 54 on opposing sides of the base housing 30. The length of the main bar 40 in this instance is arranged to fully span the interior of the base housing 30 between the parallel and opposed internal frame members 54.

Mounting apertures 44 are similarly provided in the flanges 42 of the second embodiment so that a fastener secured to the end of each axle 58 received through the mounting aperture is similarly secured and restricted from longitudinal sliding movement in the direction of the axle between the flanges 42 at each end of the main bar. In this instance even if the outer fastener of the axle 58 or the wheels were cut off at the axle, the remaining portion of the axle extending through the internal frame members 54 remains fixed and restricted from sliding removal into the interior of the underside of the base housing due to the fasteners at the interior ends of the axles being stuck between the flanges 42.

In this second embodiment, the tongue 16 similarly projects towards the opening 32 in the upper side of the base housing so that the aperture at the free end of the tongue again remains accessible for insertion of the locking member 28 once inserted through the eye of the anchor.

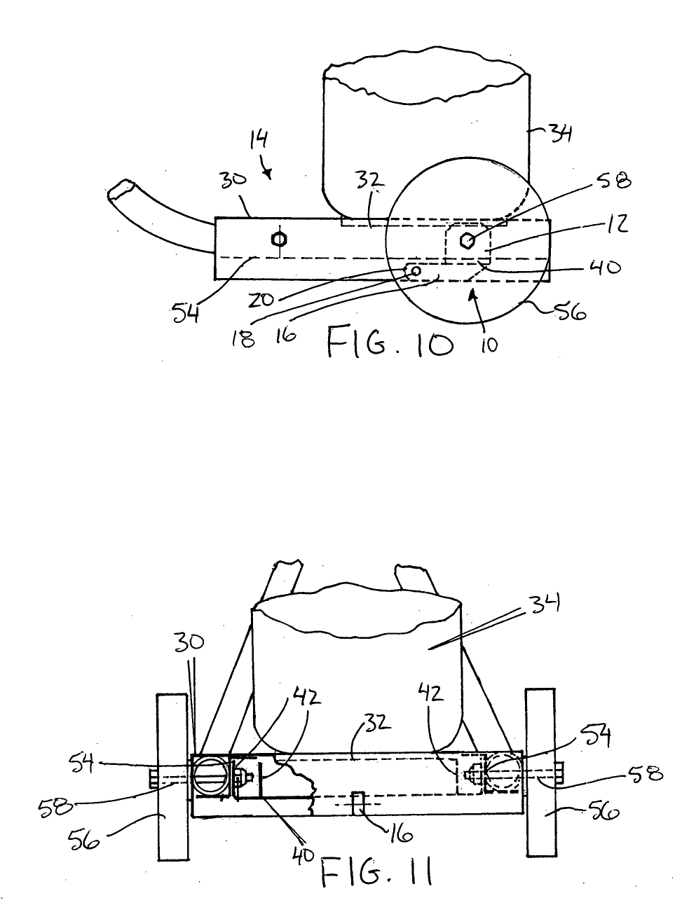

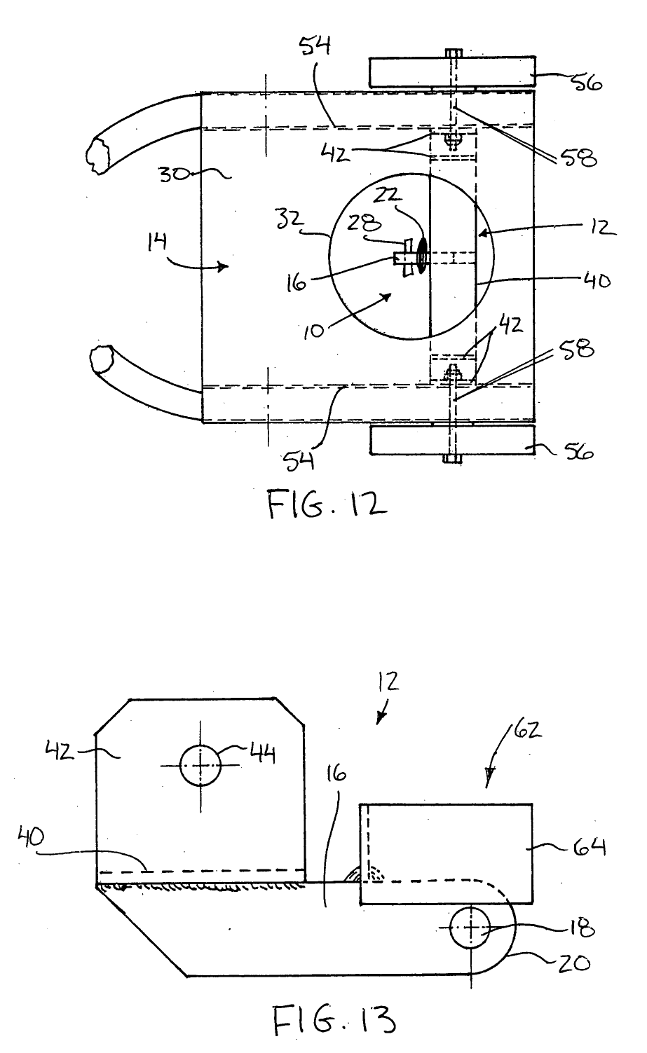

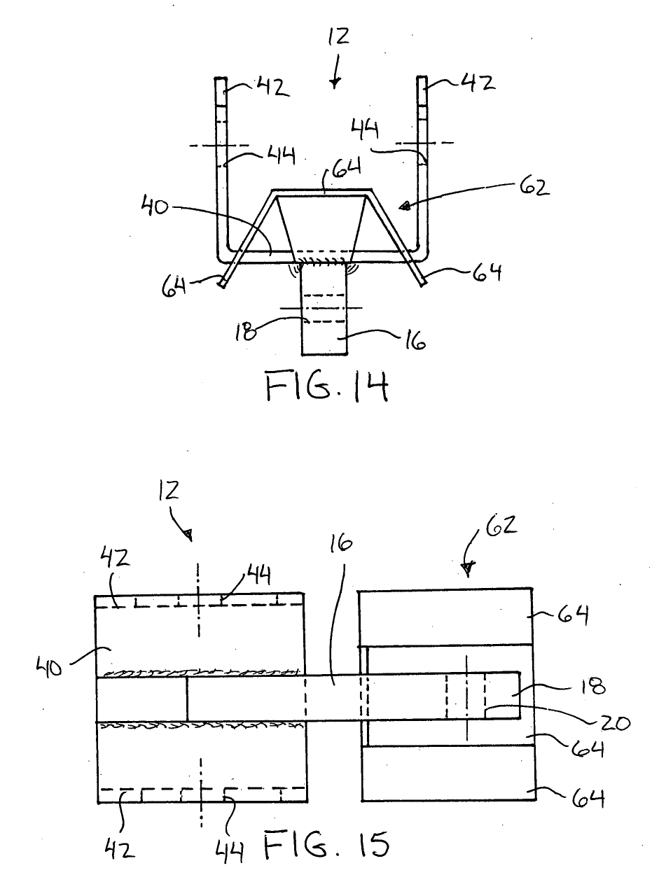

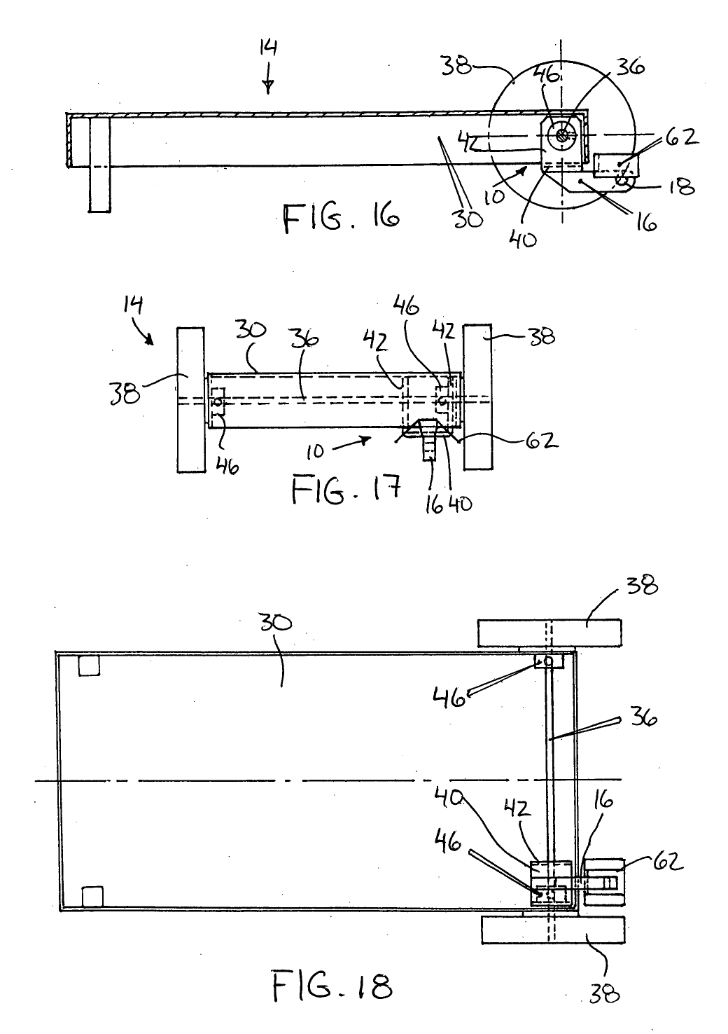

Turning now to FIGS. 13 through 18, a third embodiment of the anti-theft device will now be described in further detail. The bracket in this instance again comprises a main bar 40 which is reduced in length in relation to the previous embodiments. Only two mounting flanges 42 project from the main bar perpendicularly thereto at spaced positions parallel to one another. Each flange includes a mounting aperture 44 therein for slidably receiving the axle 60 of the appliance there through.

The appliance, for which the third embodiment is particularly suited to, includes a rectangular base housing 30 having a rectangular upper surface and side walls depending from side edges thereof. An axle extends through apertures in opposing side walls of the base housing for mounting wheels 38 at opposing ends of the axle 36. Locking collars 46 are again provided at opposing ends of the axle 36 secured thereto from an underside of the appliance to restrict relative sliding movement of the axle relative to the housing of the appliance.

One of the mounting flanges 42 of the bracket is secured between one of the locking collars and a side wall of the base housing so that the bracket is also similarly restricted from sliding movement relative to the axle or the housing. Due to the lack of an opening in the base housing, in this embodiment the tongue 16 instead projects outwardly away from the housing so that a free end of the tongue locating the locking aperture therein is no longer beneath the base housing. The tongue and locking member 28 received therethrough as well as the surrounding eye 26 are instead protected from tampering in this embodiment by a guard 62 in the form of a plurality of guard flanges 64 which project over the tongue parallel and spaced therefrom and which project downwardly and outward at an incline at opposing side edges to partially surround the eye and locking aperture at the tongue 16. The guard flanges 64 are all welded at a common base onto the tongue so as to remain in fixed relationship with the tongue in use.

Assembly in this instance is similarly arranged by inserting the axle through both the appliance and the mounting flanges of the bracket with the axle being subsequently secured by locking collars 46. The appliance is then rolled along the ground on its wheels until the tongue 16 aligns with the eye of the anchor and is inserted therethrough. Once the locking member 28 is secured in the locking aperture of the tongue, the tongue is restricted from removal from the anchor as in previous embodiments.

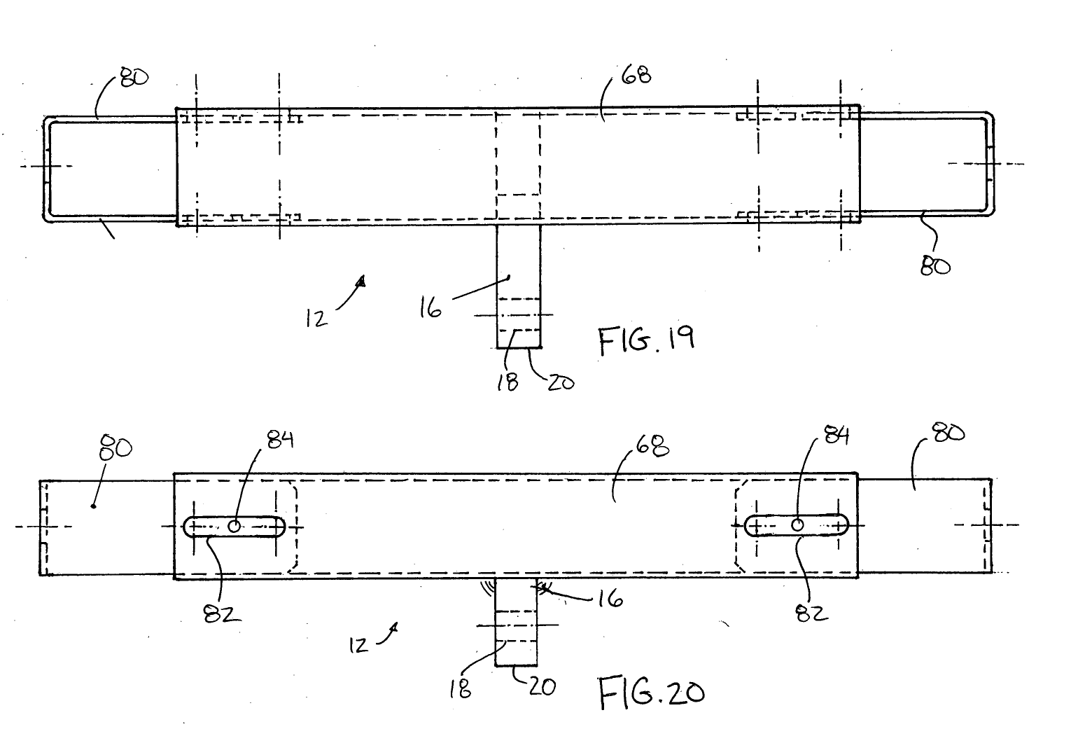

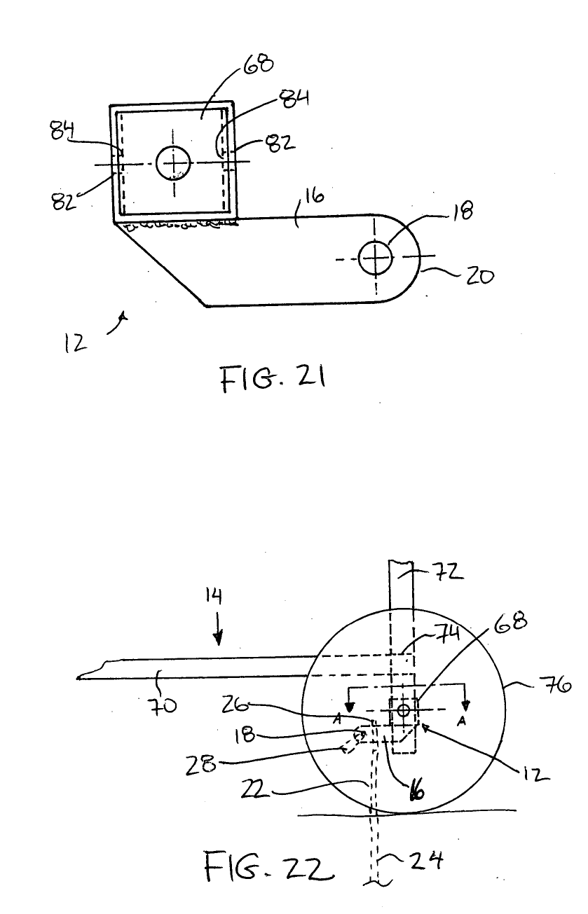

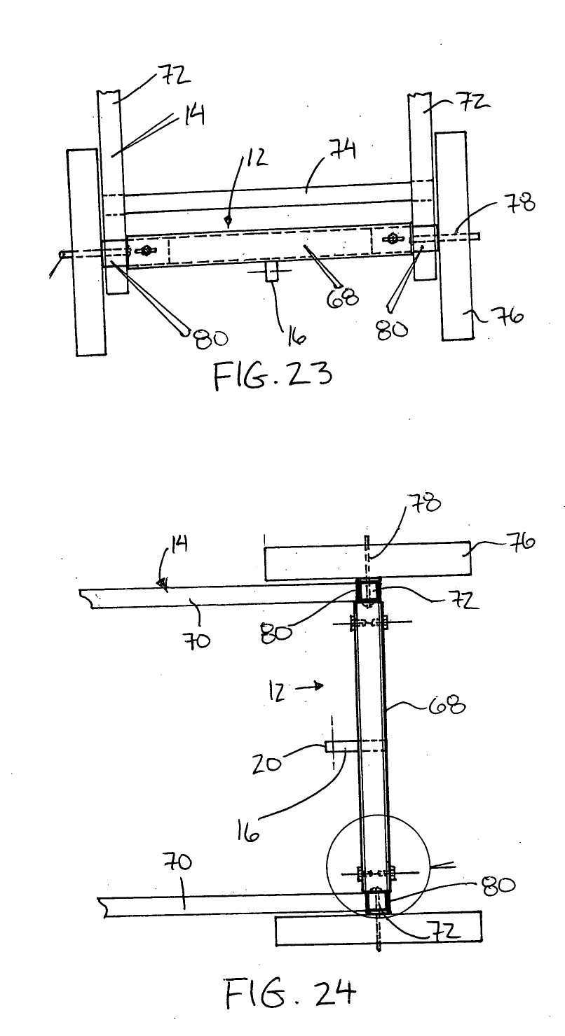

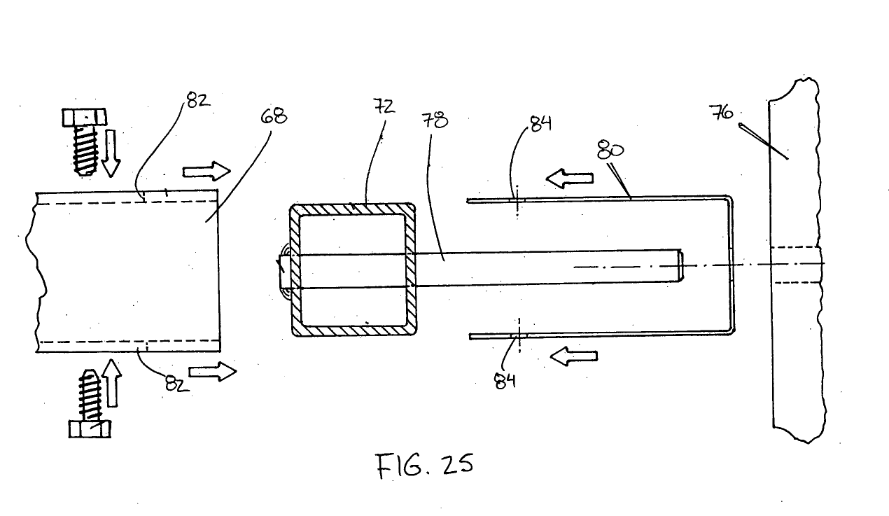

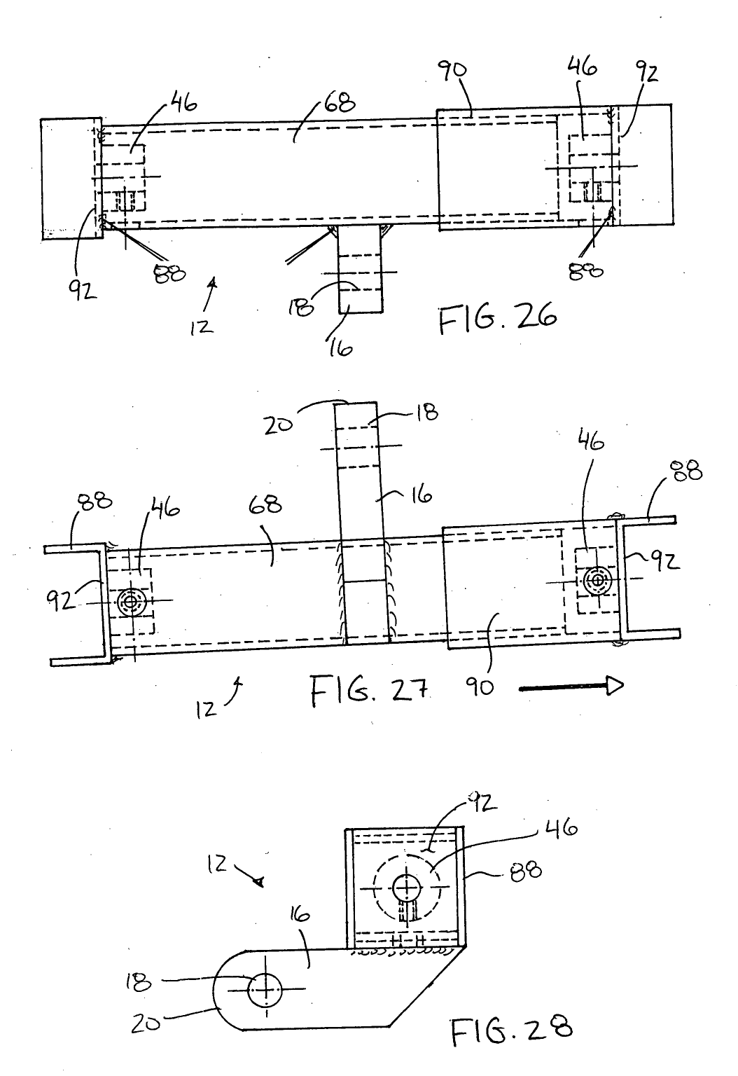

Turning now to FIGS. 19 through 25 a fourth embodiment of the anti-theft device is illustrated. The bracket in this instance comprises a main bar 68 in the form of tubing of rectangular cross section of sufficient length to span between opposing frame members 70 of the appliance illustrated to which the fourth embodiment of the device is particularly suited. The base of the appliance in this instance comprises upright posts 72 which are parallel and spaced apart, which are secured to the frame members 70 respectively. A cross bar 74 spans between the posts 72 for maintaining the posts and the frame members parallel and spaced apart. Each post 72 mounts a wheel 76 at a lower end thereof on a respective axle 78 extending through apertures in the post and mounting the wheel at an outer end thereof externally of the frame of the appliance. The appliance in this instance is any one of numerous types of propane barbecues or other similar appliances having the noted configuration.

End clips 80 are received within opposing ends of the main bar 68 in use. Each end clip is a generally U-shaped member having a base portion at an outer free end of the device in which a mounting aperture is located for receiving a respective one of the axles 78 of the wheels therein when the base is secured between the post and the respective wheel. The end portions of each end clip 80 are slidably received within the open ends of the main bar 68 and are suitably sized for being snugly received between opposing side walls of the bar.

Elongate mounting slots 82 extend in the longitudinal direction in opposing side walls at each end of the main bar 68 for cooperation with respective mounting apertures 84 in the opposing side portions of the end clips 80. When the mounting slots 82 are aligned with the mounting apertures 84, fasteners are used to secure the main bar 68 in relation to the end clips 80, the posts 72 clamped by the end clips and the axles 78 slidably received through the posts and end clips. Suitable adhesive for securing the fasteners may be used as desired. The tongue 16 in this instance is again mounted perpendicularly to the main bar 68 to project horizontally therefrom to a free end locating the locking aperture 18 therein spaced from the bracket for slidably receiving the tongue within the eye of the anchor 22 for subsequent securement by a locking member as described in previous embodiments.

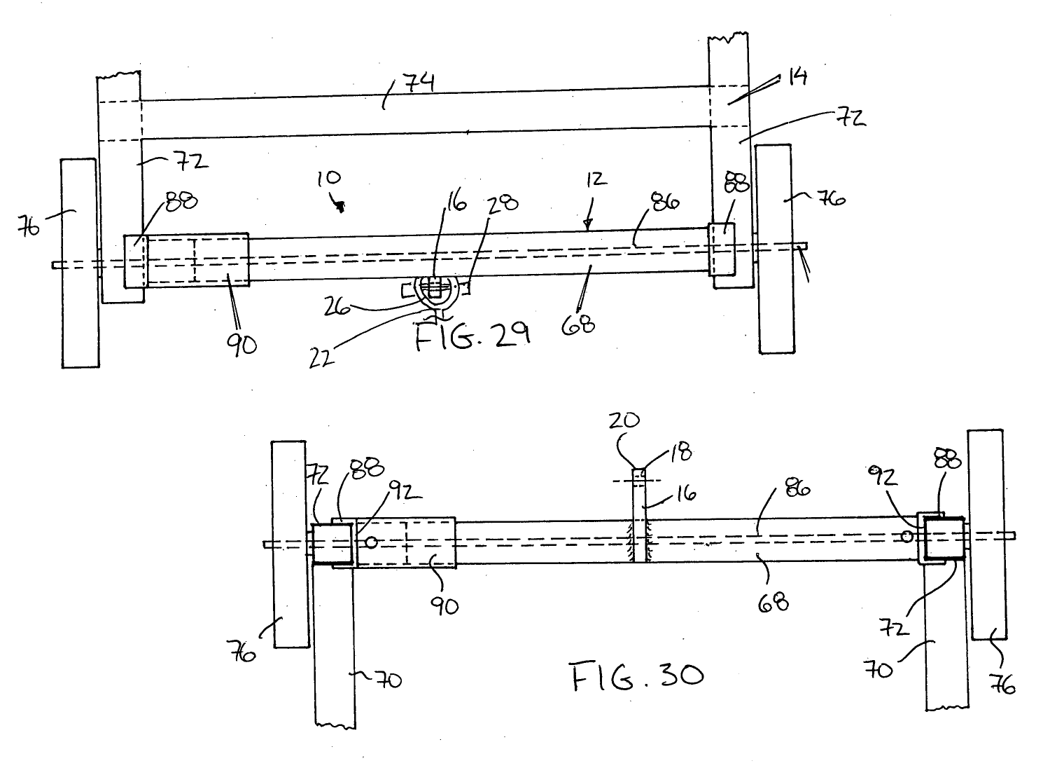

A fifth embodiment will now be described herein as illustrated in FIGS. 26 through 30. This embodiment of the anti-theft device is particularly suited for appliances having a pair of opposed posts 72 joined by a cross bar 74 and having frame members 70 as in the previous embodiment, with the exception that a single axle 86 be provided which spans between both posts 72 for mounting one of the wheels 76 on each end thereof. The device again includes a main bar 68 in the form of a hollow tube of square cross section which in this instance slidably receives the axle 86 therethrough.

Opposed clamping members 88 are provided at opposing ends of the tubing which are slidable relative to one another for being extended between the posts 72 for being clamped therebetween when fully extended. One of the clamping members 88 is fixed to the tubing of the main bar while the opposing clamping member is slidable on a telescoping section 90 of the main bar 68.

The clamping members are generally U-shaped in configuration having a base portion 92 and a pair of spaced apart side flanges projecting perpendicularly therefrom. The base portion of each of the clamping members 88 includes a locking collar 46 formed therein with a set screw used to secure the collar in a fixed position on the axle. The tongue 16 in this embodiment again projects perpendicularly to the main bar horizontally across the ground for being slidably received within the eye of an anchor as in previous embodiments.

By providing one of the clamping members at one end of the main bar on a telescoping section 90 the length of the main bar is adjustable to permit attachment on various styles of appliances in which a pair of opposed posts are provided. The use of locking collars at the ends of the main bar ensures that the main bar remains fixed in its fully extended position and fully secured position between the posts and surrounding the axle. The set screws of the locking collars are only accessible from an underside so as to be restricted from tampering once the anti-theft device is secured in place and anchored to an anchor 22 as described above.

As illustrated in FIG. 31, in certain applications the clamping members 88 may be varied in shape to have a generally semi-circular cross section for being securely clamped between tubular posts 72 which are circular in cross section. A locking collar 46 is again provided at the base of each clamping member 88 for use as described above.

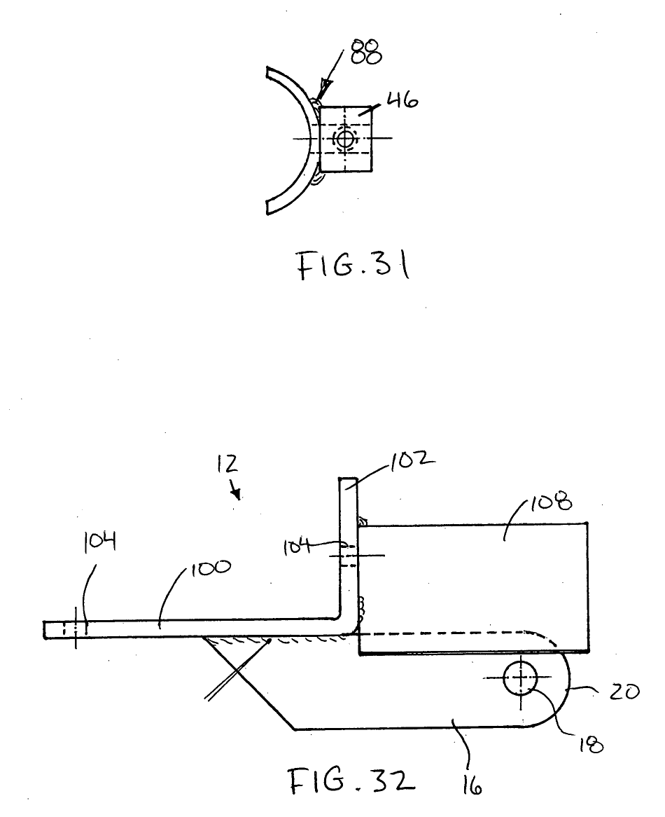

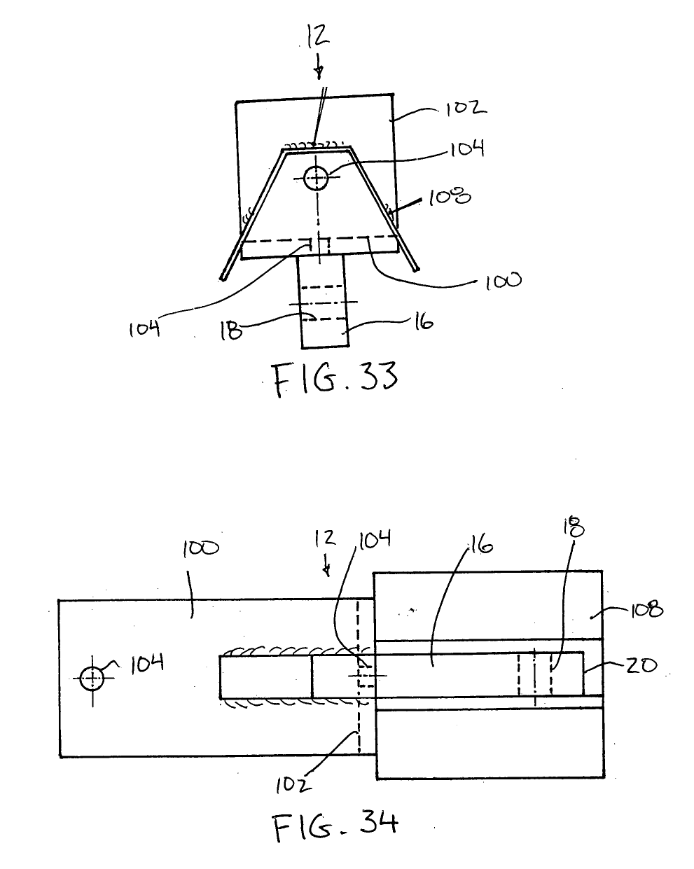

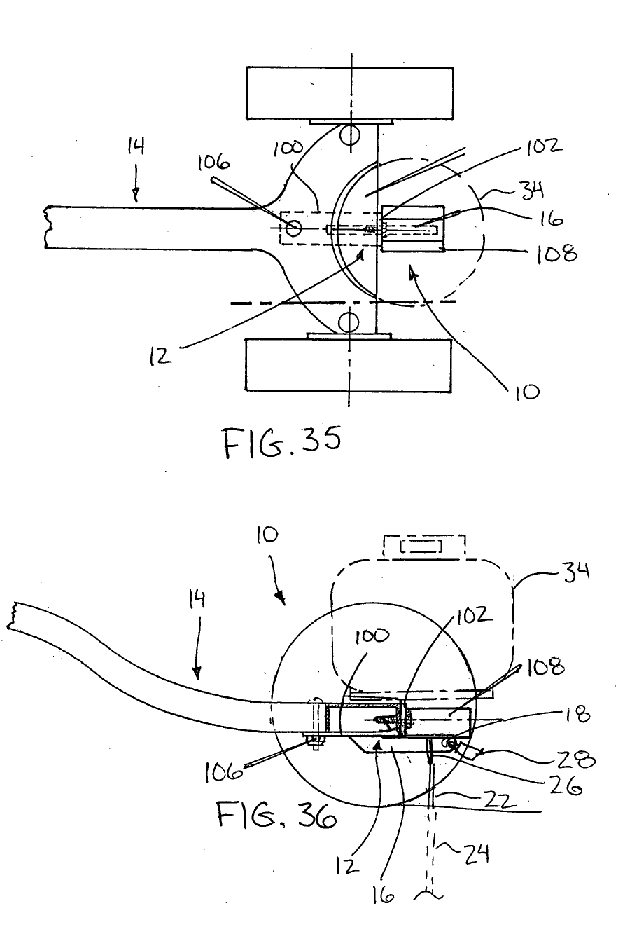

Finally turning to FIGS. 32 through 36, a sixth embodiment of the anti-theft device is illustrated. The sixth embodiment is particularly useful for appliances having a base housing of unusual shape to which a fitted bracket is difficult to secure to the axle. The bracket in this instance includes a base mounting flange 100 and an upright mounting flange 102 mounted perpendicularly to the base flange at one end thereof. Each of the flanges includes a suitable mounting aperture 104 therein for receiving a fastener for securement to the base housing of the appliance.

In the instance where the base of the appliance includes a centrally located carriage bolt 106, the length of the base mounting flange 100 is arranged so that the mounting aperture therein aligns with the carriage bolt while the upright mounting flange abuts against a side wall of the base housing. The mounting aperture in the base flange is thus secured by the carriage bolt while an additional fastener is used to secure the mounting aperture in the upright flange to a side wall portion of the base housing of the appliance. The tongue 16 in this instance is secured to the base mounting flange 100 to project outwardly beyond the upright mounting flange to be exposed externally from the underside of the housing.

A guard 108 is provided in the form of a plurality of flanges projecting parallel and spaced from the tongue thereabove with sides of the guard projecting downwardly and outwardly at an incline to partially surround the tongue and protect the eye and the locking aperture at the tongue in the assembled position in which the tongue extends through the eye of the anchor and is secured by the locking member 28 as in previous embodiments.

As described herein, the anti-theft device 10 is particularly useful for a variety of portable wheeled appliances including numerous configurations of propane barbecues or propane consuming mosquito traps and the like. The device is used in cooperation with an anchor 22 and a locking member 28 for securing the appliance to the anchor. In place of a ground anchor, the appliance can readily be secured to anchors on decks or embedded within concrete and the like. In all embodiments a bracket is provided for securement to the appliance which includes a tongue projecting therefrom for being slidably received within the eye of the anchor. The bracket is typically secured to the axle of the appliance within an underside of the base housing however in certain embodiments the bracket may be adjustable in nature for accommodating different sizes of appliances or the bracket may simply be bolted onto the housing or other parts of the appliance. In all instances some form of protection for the tongue is provided in the form of guard flanges or by concealing the tongue within an underside of the housing. Additional features of securement of the axle to restrict sliding removal thereof and welding shut the eye of the anchor additionally secure the appliance. In most applications the bracket is fully concealed for both being aesthetically pleasing as well as being more difficult to tamper with. The configuration of the anti-theft device permits it to remain fixed on the appliance with removal from the anchor being accomplished by simply removing the locking member. Plural anchors may be provided within a designated area to permit the appliance to be readily moved from one location to another with only the locking member being disconnected and reattached in each instance. The locking members are all preferably case hardened to be more difficult to remove.

While various embodiments of the present invention have been described in the foregoing, it is to be understood that other embodiments are possible within the scope of the invention. The invention is to be considered limited solely by the scope of the appended claims.

1. An anti-theft device for a portable appliance, the device comprising:
an anchor having an eye and an anchoring portion for securement to either the ground or a similarly fixed object;
a mounting bracket for securement to the portable appliance; and
a tongue projecting from the bracket and being suitable sized for being slidable into the eye of the anchor;
the tongue locating a locking aperture in a free end thereof to receive a locking member therethrough for selectively restricting removal of the tongue from the eye of the anchor.

2. The anti-theft device according to claim 1 wherein the bracket is suitably arranged for securement below a base of the appliance and wherein the tongue projects below the bracket for concealment below the base of the appliance.

3. The anti-theft device according to claim 1 wherein the bracket is suitably arranged for securement to an axle of the appliance.

4. The anti-theft device according to claim 1 wherein the bracket includes spaced apart apertures therein for slidably receiving an axle of the appliance therethrough and for securement at spaced positions along the axle.

5. The anti-theft device according to claim 1 wherein there is provided axle locking means for securement of the bracket to the axle and for restricting longitudinal sliding movement of the axle relative to the bracket.

6. The anti-theft device according to claim 5 wherein the bracket includes a pair of spaced apart flanges having apertures therein for slidably receiving an axle of the appliance therethrough and wherein the axle locking means are securable to the axle between the spaced apart flanges.

7. The anti-theft device according to claim 1 wherein the bracket includes a pair of axle mounts which are slidably supported relative to one another for mounting on an axle of the appliance at adjustably spaced locations.

8. The anti-theft device according to claim 1 wherein there is provided a guard flange at least partially surrounds the tongue, spaced outwardly from the tongue.

9. The anti-theft device according to claim 1 wherein the eye of the anchor is welded to form a closed loop.

10. The anti-theft device according to claim 1 wherein the anchoring portion of the anchor comprises a threaded rod for securement with suitable threaded nuts.

11. The anti-theft device according to claim 1 wherein the anchoring portion of the anchor comprises flighting which is suitably arranged for insertion into the ground.

12. The anti-theft device according to claim 1 wherein the bracket is arranged for securement to a portable propane consuming appliance.

13. The anti-theft device according to claim 1 wherein the bracket includes mounting apertures for securement to a frame of the appliance using suitable fasteners.

14. The anti-theft device according to claim 1 wherein fasteners used for securement of the bracket to the appliance are secured using a suitable adhesive compound.

15. A method of securing a portable propane appliance, the method comprising:
providing an anti-theft device including an anchor having an eye and an anchoring portion and a bracket having a tongue for being slidably received in the eye and a locking aperture at a free end of the tongue;
securing the anchoring portion of the anchor to either the ground or a similarly fixed object;
securing the bracket to the appliance;
inserting the tongue of the bracket through the eye of the anchor; and
securing a locking member through the locking aperture in the tongue so as to restrict removal of the tongue from the eye.

16. The method according to claim 15 including securing the bracket to an axle of the appliance.

17. The method according to claim 15 including concealing the bracket beneath and base of the appliance.

18. The method according to claim 15 including surrounding the tongue by a suitable guard member.

19. The method according to claim 15 including providing flighting on the anchoring portion of the anchor suitable for penetration into the ground.

20. The method according to claim 15 including welding an eye of the anchor to form a closed loop.
